(19) United States
(12) Patent Application Publication
(10) Pub. No.: US 2024/0125490 A1
(43) Pub. Date: Apr. 18, 2024

(54) VENTILATION APPARATUS AND VENTILATION SYSTEM HAVING THE SAME

(71) Applicant: Samsung Electronics Co., Ltd., Suwon-si (KR)

(72) Inventors: Jaehyoung SIM, Suwon-si (KR); Kyunghoon KIM, Suwon-si (KR); Sunggoo KIM, Suwon-si (KR); Hyeongjoon SEO, Suwon-si (KR); Eomji JANG, Suwon-si (KR); Sungjune CHO, Suwon-si (KR); Taesung CHOI, Suwon-si (KR)

(21) Appl. No.: 18/391,319

(22) Filed: Dec. 20, 2023

Related U.S. Application Data
(63) Continuation of application No. PCT/KR2022/011020, filed on Jul. 27, 2022.

(30) Foreign Application Priority Data
Aug. 18, 2021 (KR) 10-2021-0108945

(51) Int. Cl. F24F 3/147; B01D 46/00; B01D 46/42; B01D 53/26; B01D 53/88; F24F 8/108; F24F 12/00

(52) U.S. Cl. CPC F24F 3/147; B01D 46/0049; B01D 46/4263; B01D 53/265; B01D 53/88; F24F 8/108; F24F 12/006; F24F 2003/1446

(57) ABSTRACT

The present disclosure relates to a ventilation apparatus including a housing including: an intake flow path provided to draw outdoor air into an indoor space and an discharge flow path provided to discharge indoor air to the outside, a cover covering the housing, a total heat exchanger configured to exchange heat between air flowing in the intake flow path and air flowing in the discharge flow path, and a dehumidification unit including a heat exchanger provided on the intake flow path configured to remove moisture in the air flowing in the intake flow path and a drain tray configured to collect condensate generated from the heat exchanger, wherein the housing includes a first housing including a first hole asymmetrically formed on one surface of the housing with respect to a center line of the one surface extending in a long axis direction and a short axis direction of the one surface and configured to allow the drain tray and the total heat exchanger to be withdrawn from the outside of the housing, and a second housing coupled to the first housing in an up-down direction and including a second hole disposed on an other surface of the housing and having a shape corresponding to the first hole in the up-down direction, wherein the cover includes a first cover forming a lower portion of the cover and a second cover coupled to the first cover in the up-down direction and forming an upper portion of the cover, and wherein one of the first housing and the second housing is covered by the first cover, and an other one of the first housing and the second housing is covered by the second cover.

### CROSS-REFERENCE TO RELATED APPLICATIONS

This application is a continuation of International Application No. PCT/KR2022/011020 designating the United States, filed on Jul. 27, 2022, in the Korean Intellectual Property Receiving Office and claiming priority to Korean Patent Application No. 10-2021-0108945, filed on Aug. 18, 2021, in the Korean Intellectual Property Office, the disclosures of each of which are incorporated by reference herein in their entireties.

### BACKGROUND

### Field

The disclosure relates to a ventilation apparatus, and for example, to a ventilation apparatus capable of providing pleasant air and a ventilation system having the same.

### Description of Related Art

A ventilation apparatus is an apparatus capable of supplying outdoor air to an indoor space or exchanging indoor air with outdoor air to ventilate to the indoor space.

A conventional ventilation apparatus has no choice but to regulate an indoor temperature and humidity only through total heat exchange between outdoor air and indoor air that occurs while passing through a total heat exchanger. Therefore, dehumidification of outdoor air supplied to an indoor space is incomplete, and it is difficult to maintain the indoor temperature and humidity in a comfortable state.

### SUMMARY

Embodiments of the disclosure may provide a ventilation apparatus capable of regulating a humidity of air supplied to an indoor space to a comfortable state and a ventilation system having the same.

Embodiments of the disclosure may provide a pair of ventilation apparatuses capable of being arranged symmetrically left and right with the same configuration in the pair of ventilation apparatuses required to be arranged symmetrically left and right, and a ventilation system having the same.

Embodiments of the disclosure may provide a ventilation apparatus capable of circulating indoor air as well as outdoor air to regulate air supplied to an indoor space to have a comfortable humidity, and a ventilation system having the same.

According to an example embodiment of the present disclosure a ventilation apparatus may include: a housing including an intake flow path configured to draw outdoor air into an indoor space and an discharge flow path configured to discharge indoor air to the outside, a cover covering the housing, a total heat exchanger configured to exchange heat between air flowing in the intake flow path and air flowing in the discharge flow path, and a dehumidification unit including a heat exchanger provided on the intake flow path and configured to remove moisture in the air flowing in the intake flow path and a drain tray configured to collect condensate generated from the heat exchanger, wherein the housing includes a first housing including a first hole asymmetrically formed on one surface of the housing with respect to a center line of the one surface extending in a long axis direction and a short axis direction of the one surface and configured to allow the drain tray and the total heat exchanger to be withdrawn from the outside of the housing, and a second housing coupled to the first housing in an up-down direction and including a second hole disposed on an other surface of the housing and having a shape corresponding to the first hole in the up-down direction, wherein the cover includes a first cover forming a lower portion of the cover and a second cover coupled to the first cover in the up-down direction and forming an upper portion of the cover, and wherein one of the first housing and the second housing is covered by the first cover, and an other one of the first housing and the second housing is covered by the second cover.

The ventilation apparatus according to an example embodiment may further include: a filter disposed on the intake flow path and configured to remove foreign substances in air flowing to the total heat exchanger, wherein the filter may be configured to be withdrawn to the outside of the housing through the first hole.

The housing according to an example embodiment may include: a first intake port configured to allow air to be introduced into the intake flow path and a first discharge port configured to allow the air flowing in the intake flow path to be discharged to the outside of the housing, wherein the filter may be positioned closer to the first intake port than an intake end of the total heat exchanger disposed on the intake flow path and disposed to be parallel to and in close contact with the intake end of the total heat exchanger disposed on the intake flow path.

The total heat exchanger according to an example embodiment may have a square cross section, the first hole may include a first area in which the total heat exchanger and the filter are configured to be withdrawn and a second area in which the drain tray is configured to be withdrawn, and the first area may be provided in a rectangular shape.

The housing according to an example embodiment may include: a first intake port disposed on one side of the housing and configured to allow air to be introduced into the intake flow path, a first discharge port disposed on an other side opposite to the one side of the housing and configured to allow air flowing in the intake flow path to be discharged to the outside of the housing, a second intake port disposed on the other side of the housing and configured to allow air to be introduced into the discharge flow path, and a second discharge port disposed on the one side of the housing and configured to allow air flowing in the discharge flow path to be discharged to the outside of the housing, wherein the total heat exchanger may be disposed closer to the one side of the housing than the other side of the housing based on a center line extending from a center of the one side and the other side of the housing in a direction in which the one side and the other side of the housing extend.

The first hole according to an example embodiment may include: a first area in which the total heat exchanger is configured to be withdrawn and a second area in which the drain tray is configured to be withdrawn, and the first area may be disposed closer to the one side of the housing than the other side of the housing based on the center line extending from the center of the one side and the other side of the housing in the direction in which the one side and the other side of the housing extend.

The housing according to an example embodiment may include: a first intake chamber forming one portion of the intake flow path and formed between the first intake port and the total heat exchanger, a second intake chamber forming the other portion of the intake flow path and formed between the total heat exchanger and the first discharge port, a first exhaust chamber forming one portion of the discharge flow path and formed between the second intake port and the total heat exchanger, and a second exhaust chamber forming the other portion of the discharge flow path and formed between the total heat exchanger and the second discharge port, wherein the dehumidification unit may be disposed in the second intake chamber.

The second intake chamber according to an example embodiment may have a larger internal space than the first intake chamber, the first exhaust chamber, and the second exhaust chamber.

The first housing according to an example embodiment may include: a first intake port forming part forming one portion of the first intake port, a first discharge port forming part forming one portion of the first discharge port, a second intake port forming part forming one portion of the second intake port, and a second discharge port forming part forming one portion of the second discharge port, the second housing may include: a first intake port forming part forming the other portion of the first intake port, a first discharge port forming part forming the other portion of the first discharge port, a second intake port forming part forming the other portion of the second intake port, and a second discharge port forming part forming the other portion of the second discharge port, wherein the first discharge port forming part of the first housing and the first discharge port forming part of the second housing, the first intake port forming part of the first housing and the first intake port forming part of the second housing, the second discharge port forming part of the first housing and the second discharge port forming part of the second housing, and the second intake port forming part of the first housing and the second intake port forming part of the second housing may be formed symmetrically in the up-down direction, respectively.

The ventilation apparatus according to an example embodiment may further include: a first blower configured to flow air in the intake flow path and a second blower configured to flow air in the discharge flow path, wherein the first blower may communicate with the first discharge port, and the second blower may communicate with the second discharge port.

The first discharge port forming part of the first housing and the second discharge port forming part of the first housing according to an example embodiment may have the same shape.

The ventilation apparatus according to an example embodiment may further include: a humidification unit including a humidifier detachably disposed on the intake flow path configured to supply moisture in the air flowing in the intake flow path, wherein the dehumidification unit may be detachably disposed on the intake flow path, and one of the humidification unit and the dehumidification unit may be selectively disposed on the intake flow path.

The first cover according to an example embodiment may include: a body part and a surface part detachably coupled to the body part and disposed to face the other surface of the housing, wherein the surface part may include a third hole having a shape corresponding to the first hole in the up-down direction.

The surface part according to an example embodiment may include: a first surface facing the other surface of the housing and a second surface disposed on an opposite side of the first surface, the first surface may be coupled to the body part to face the first housing based on the first housing being covered by the first cover, and the second surface may be coupled to the body part to face the second housing based on the second housing being covered by the first cover.

The housing according to an example embodiment may comprise an insulation material.

Another example embodiment of the present disclosure may provide a ventilation system including: an outdoor unit and a ventilation apparatus connected to the outdoor unit configured to supply air to an indoor space, wherein the ventilation apparatus includes a housing including an intake flow path configured to draw outdoor air into the indoor space and an discharge flow path configured to discharge indoor air to the outside, a cover configured to cover the housing, a total heat exchanger configured to exchange heat between air flowing in the intake flow path and air flowing in the discharge flow path, and a dehumidification unit including a heat exchanger provided on the intake flow path and configured to remove moisture in the air flowing in the intake flow path and connected to the outdoor unit and a drain tray configured to collect condensate generated from the heat exchanger, wherein the housing includes a first housing including a first hole asymmetrically formed on one surface of the housing with respect to a center line of the one surface extending in a long axis direction and a short axis direction of the one surface and configured to allow the drain tray and the total heat exchanger to be withdrawn from the outside of the housing, and a second housing coupled to the first housing in an up-down direction and including a second hole disposed on the other surface of the housing and having a shape corresponding to the first hole in the up-down direction, wherein the cover includes a first cover forming a lower portion of the cover and a second cover coupled to the first cover in the up-down direction and forming an upper portion of the cover, and wherein one of the first housing and the second housing is selectively covered by the first cover, and the other one of the first housing and the second housing is covered by the second cover.

The ventilation system according to an example embodiment may further include: a filter disposed on the intake flow path configured to remove foreign substances in air flowing to the total heat exchanger, wherein the filter may be configured to be withdrawn to the outside of the housing through the first hole.

The housing according to an example embodiment may include: a first intake port configured to allow air to be introduced into the intake flow path and a first discharge port configured to allow the air flowing in the intake flow path to be discharged to the outside of the housing, wherein the filter may be positioned closer to the first intake port than an intake end of the total heat exchanger disposed on the intake flow path and disposed to be parallel to and in close contact with the intake end of the total heat exchanger disposed on the intake flow path.

The total heat exchanger according to an example embodiment may have a square cross section, the first hole may include a first area in which the total heat exchanger and the filter are configured to be withdrawn and a second area in which the drain tray is configured to be withdrawn, and the first area may have a rectangular shape.

Another example embodiment of the present disclosure provides a ventilation apparatus including: a housing including an intake flow path configured to draw outdoor air into an indoor space and an discharge flow path configured to discharge indoor air to the outside, a cover provided to cover the housing, a total heat exchanger configured to exchange heat between air flowing in the intake flow path and air flowing in the discharge flow path, and a dehumidification unit including a heat exchanger provided on the intake flow path configured to remove moisture in the air flowing in the intake flow path and a drain tray provided to collect condensate generated from the heat exchanger, wherein the housing includes: a first housing including a first hole asymmetrically formed on one surface of the housing with respect to a center line of the one surface extending in a long axis direction and a short axis direction of the one surface and configured to allow the drain tray and the total heat exchanger to be withdrawn from the outside of the housing, and a second housing coupled to the first housing in an up-down direction and including a second hole disposed on the other surface of the housing and having a shape corresponding to the first hole in the up-down direction, and wherein the first hole of the first housing and the second hole of the second housing are provided in a mirror symmetrical shape about a center line between the first housing and the second housing based on one surface and the other surface of the housing being arranged on the same surface in parallel in a long or short axis direction of the one surface.

A ventilation apparatus according to various example embodiments of the present disclosure can regulate a humidity of drawn outdoor air using a heat exchanger disposed on an intake flow path and then discharge the outdoor air to an indoor space, so that a humidity in an indoor space can be comfortably maintained.

A pair of the ventilation apparatuses arranged symmetrically left and right are implemented with the same configuration, so that production costs can be reduced.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating a ventilation system according to various embodiments;

FIG. 2 is a diagram illustrating a first type ventilation apparatus viewed from top toward bottom in a state in which a part of a configuration thereof is removed in ventilation apparatuses illustrated in FIG. 1 according to various embodiments;

FIG. 3 is a diagram illustrating air flows in the ventilation system according to various embodiments;

FIG. 4 is an exploded perspective view of the first type ventilation apparatus illustrated in FIG. 1 according to various embodiments;

FIG. 5 is a perspective view illustrating the first type ventilation apparatus viewed from bottom toward top in a state in which a part of the configuration thereof is removed in the ventilation apparatuses illustrated in FIG. 1 according to various embodiments;

FIG. 6 is a perspective view of a second housing of the first type ventilation apparatus illustrated in FIG. 1 according to various embodiments;

FIG. 7 is a perspective view of a first housing of the first type ventilation apparatus illustrated in FIG. 1 according to various embodiments;

FIG. 8 is a diagram illustrating upper and lower housings of the first type ventilation apparatus illustrated in FIG. 1 arranged in a left-right direction according to various embodiments;

FIG. 9 is an exploded perspective view of a second type ventilation apparatus illustrated in FIG. 1 according to various embodiments;

FIG. 10 is a diagram illustrating the second type ventilation apparatus viewed from top toward bottom in a state in which a part of a configuration thereof is removed in the ventilation apparatuses illustrated in FIG. 1 according to various embodiments;

FIG. 11 is a diagram illustrating an air flow in the first type ventilation apparatus illustrated in FIG. 1 according to various embodiments;

FIG. 12 is a diagram illustrating an air flow in a mode different from a mode of the air flow shown in FIG. 11, in the first type ventilation apparatus illustrated in FIG. 1 according to various embodiments;

FIG. 13 is a diagram illustrating a ventilation apparatus viewed from top toward bottom in a state in which a part of the configuration of the first type ventilation apparatus is removed according to various embodiments.

### DETAILED DESCRIPTION

The various example embodiments described in the present disclosure and the configurations illustrated in the drawings are only examples of example embodiments of the present disclosure, and various modifications may be made at the time of filing of the present disclosure.

Like reference numbers or signs in the various drawings of the application represent parts or components that perform substantially the same functions. The shapes and sizes of components in the drawings may be exaggerated for a clear explanation.

Throughout the disclosure, when a part is referred to as being “connected” to another part, it includes not only a direct connection but also an indirect connection, and the indirect connection includes connecting through a wireless network or connecting through another part.

The terms used herein are for describing the embodiments and are not intended to restrict and/or to limit the present disclosure. For example, the singular expressions herein may include plural expressions, unless the context clearly dictates otherwise. Also, the terms “comprises” and “has” are intended to indicate that there are features, numbers, steps, operations, components, parts, or combinations thereof described in the disclosure, and do not exclude the presence or addition of one or more other features, numbers, steps, operations, components, parts, or combinations thereof.

It will be understood that, although the terms first, second, etc. may be used herein to describe various components, these components should not be limited by these terms, and the above terms are only used to distinguish one component from another. For example, without departing from the scope of the present disclosure, a first component may be referred to as a second component, and similarly, the second component may also be referred to as a first component. The term “and/or” includes any combination of a plurality of related items or any one of a plurality of related items.

In this disclosure, the terms “front,” “rear,” “upper portion,” “lower portion,” and the like used in the following description are defined with reference to the drawings, and the shape and position of each component are not limited by these terms.

Hereinafter, various example embodiments of the present disclosure will be described in greater detail with reference to the accompanying drawings.

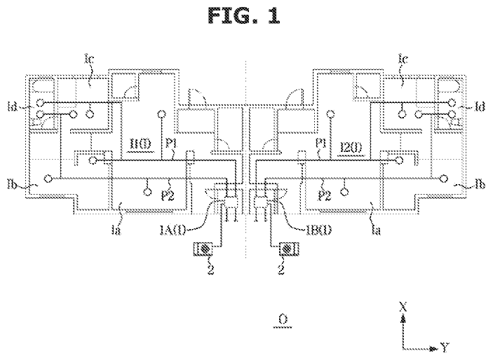

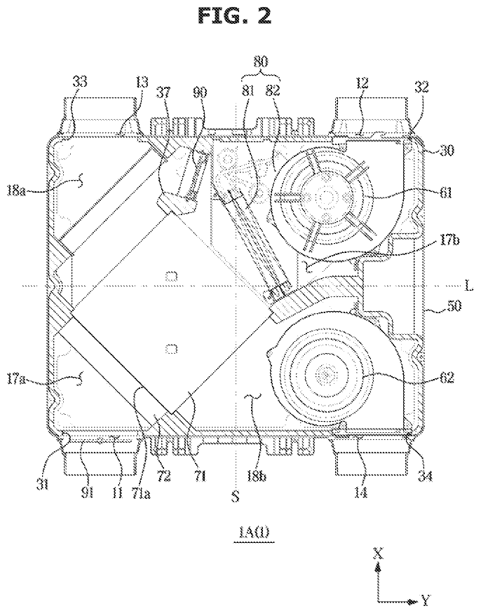

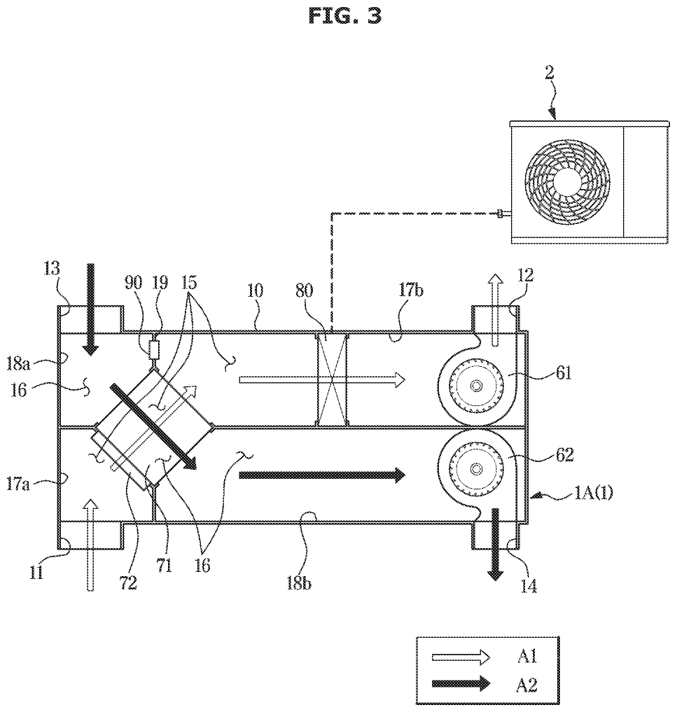

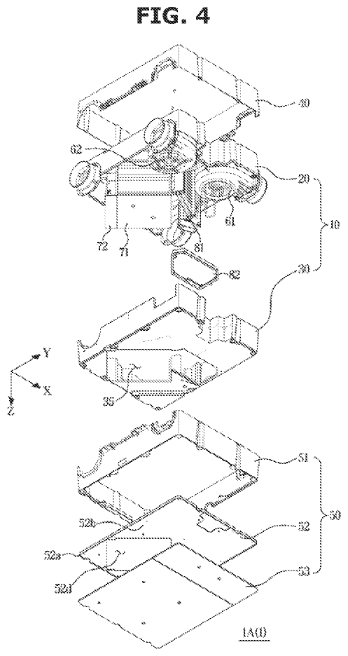

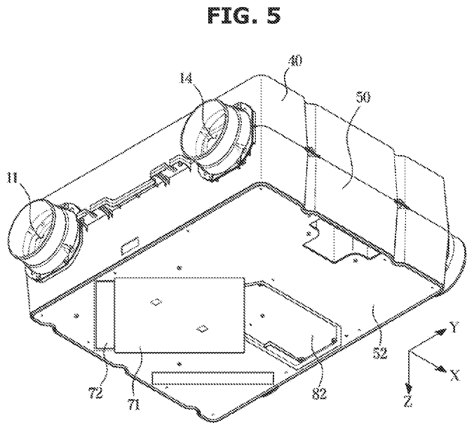

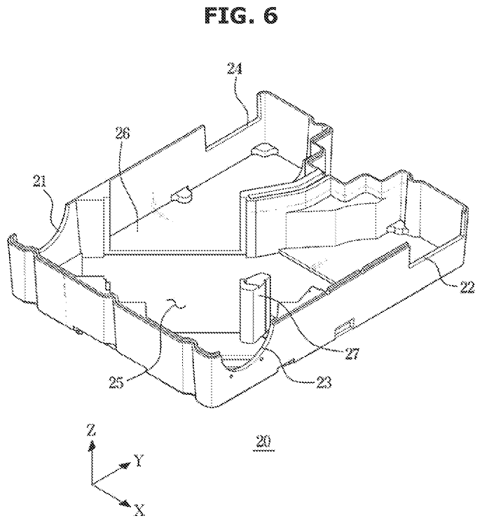

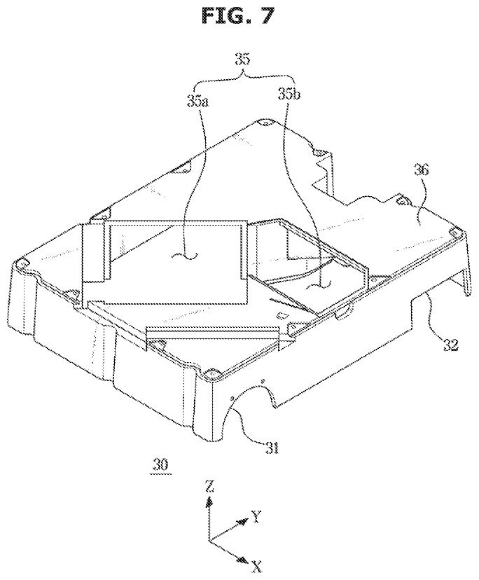

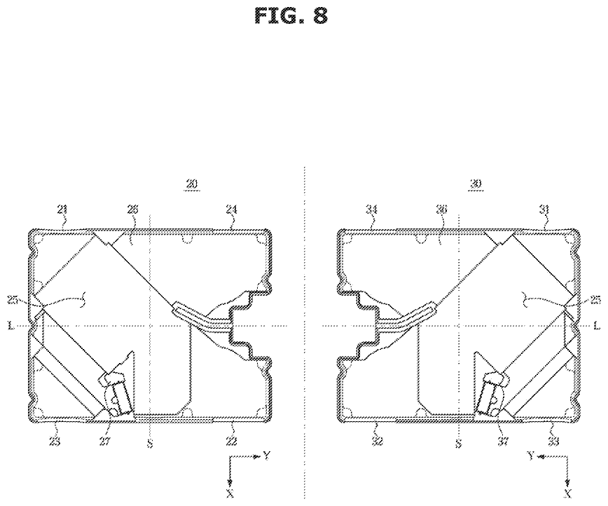

FIG. 1 is a diagram illustrating an example ventilation system according to various embodiments, FIG. 2 is a diagram illustrating a first type ventilation apparatus viewed from top toward bottom in a state in which a part of a configuration thereof is removed in ventilation apparatuses illustrated in FIG. 1 according to various embodiments, FIG. 3 is a diagram illustrating air flows in the ventilation system according to various embodiments, FIG. 4 is an exploded perspective view of the first type ventilation apparatus illustrated in FIG. 1 according to various embodiments, FIG. 5 is a perspective view illustrating the first type ventilation apparatus viewed from bottom toward top in a state in which a part of the configuration thereof is removed in the ventilation apparatuses illustrated in FIG. 1 according to various embodiments, FIG. 6 is a perspective view of a second housing of the first type ventilation apparatus illustrated in FIG. 1 according to various embodiments, FIG. 7 is a perspective view of a first housing of the first type ventilation apparatus illustrated in FIG. 1 according to various embodiments, and FIG. 8 is a diagram illustrating upper and lower housings of the first type ventilation apparatus illustrated in FIG. 1 arranged in a left-right direction according to various embodiments.

Referring to FIGS. 1, 2, 3, 4, 5, 6, 7 and 8 (which may be referred to hereinafter as FIGS. 1 to 8), a ventilation system may include ventilation apparatuses 1 provided to communicate an indoor space I and an outdoor space O to exchange indoor air and outdoor air, and outdoor units 2 provided to circulate a refrigerant supplied to the ventilation apparatuses 1.

In the present disclosure, the drawings illustrate an example configuration of an outdoor unit 2 at a practicable level. Because the outdoor unit 2 corresponds to an outdoor unit for an air conditioner commonly known in the art, those of skilled in the art may easily change or add various components necessary for implementing the outdoor unit 2. The outdoor unit 2 may be provided at a level of technology understood by those skilled in the art based on the contents of the present disclosure.

A typical ventilation system, without including the outdoor unit 2, is configured to perform heat exchange between air to be introduced into the indoor space I from the outdoor space O and air to be discharged to the outdoor space O from the indoor space I, through a total heat exchanger 71 disposed in the ventilation apparatus 1 while air is circulated between the indoor space I and the outdoor space O by the ventilation apparatus 1.

However, as the ventilation system according to an embodiment of the present disclosure includes the outdoor unit 2 and the ventilation apparatus 1 includes a heat exchanger 81 connected to the outdoor unit 2, air to be introduced into the indoor space I from the outdoor space O and the air to be discharged to the outdoor space O from the indoor space I may exchange heat with each other, and dehumidification of air supplied to the indoor space I is also possible. A detailed description of this will be given later.

The ventilation apparatus 1 may include a housing 10 forming an external appearance. The housing 10 may be provided in a substantially box shape. The housing 10 may include an intake flow path 15 to allow outdoor air to be drawn to an indoor space, and an discharge flow path 16 to allow indoor air to be discharged outdoors. The intake flow path 15 and the discharge flow path 16 may be partitioned from each other by the housing 10.

The housing 10 may include a first intake chamber 17a provided with a first intake port 11 communicating with the outdoor space O such that outdoor air A1 is drawn into the housing 10 and having the intake flow path 15 formed therein, and a second intake chamber 17b provided with a first discharge port 12 communicating with the indoor space such that the outdoor air A1 drawn into the housing 10 is discharged to the indoor space I and having the intake flow path 15 formed therein. The intake flow path 15 may connect the first intake port 11 and the first discharge port 12.

The housing 10 may include a second exhaust chamber 18a provided with a second intake port 13 communicating with the indoor space I such that indoor air A2 is drawn into the housing 10 and having the discharge flow path 16 formed therein, and a second exhaust chamber 18b provided with a second discharge port 14 communicating with the outdoor space O such that the indoor air A2 drawn into the housing 10 is discharged to the outdoor space and having the discharge flow path 16 formed therein. The discharge flow path 16 may connect the second intake port 13 and the second discharge port 14.

The ventilation apparatus 1 may include a first blower 61 disposed inside the second intake chamber 17b to generate a blowing force necessary to draw the outdoor air A1 into the indoor space and communicate with the first discharge port 12. The ventilation apparatus 1 may include a second blower 62 disposed inside the second intake chamber 18b to generate a blowing force necessary to draw the indoor air A2 into the outdoor space and communicate with the second discharge port 14.

The ventilation apparatus 1 may include the total heat exchanger 71 in which air flowing in the discharge flow path 16 and air flowing in the intake flow path 15 exchange heat with each other. The total heat exchanger 71 may correspond to a plate-type total heat exchanger or a rotary-type total heat exchanger. The total heat exchanger 71 may be disposed at a point where the intake flow path 15 and the discharge flow path 16 intersect. In other words, the total heat exchanger 71 may be referred to as being disposed on the intake flow path 15 and simultaneously on the discharge flow path 16.

The total heat exchanger 71 may communicate with the first intake chamber 17a and the second intake chamber 17b. The total heat exchanger 71 may communicate with the first exhaust chamber 18a and the second exhaust chamber 18b.

The ventilation apparatus 1 may include a filter 72 provided to remove foreign substances flowing on the outdoor air A1.

The filter 72 may be provided to collect foreign substances of a predetermined size. The filter 72 may be a high efficiency particulate air (HEPA) filter provided to collect fine dust of a predetermined size. The HEPA filter may be made of glass fiber. However, the filter 72 is not limited thereto and may be provided as various types of filters to collect foreign substances.

In addition, the filter 72 is not limited thereto and may be provided as a photocatalytic filter provided to induce a chemical action in the air using a photo catalysis. That is, the filter 72 may include the photo catalysis to sterilize various pathogens and bacteria present in the air by inducing the chemical reaction using light energy of the photo catalysis. By promoting the chemical action, odor particles in the air may be decomposed, removed, or captured.

Although not shown in the drawings, a pre-filter may be additionally provided to collect foreign substances larger than a predetermined size in the air.

The filter 72 may be disposed adjacent to the total heat exchanger 71. For example, the total heat exchanger 71 includes an intake inlet end 71a on the intake flow path 15 through which the outdoor air A1 flows, and the filter 72 may be disposed to face the intake inlet end 71a of the total heat exchanger 71.

For example, the filter 72 may be disposed to closely face the intake inlet end 71a. Therefore, the total heat exchanger 71 may be prevented/reduced from being contaminated by foreign substances, which flows in the outdoor air A1 introduced through the first intake port 11, being collected by the filter 72 before the outdoor air A1 flows into the total heat exchanger 71.

The ventilation apparatus 1 may include a dehumidification unit 80 provided to regulate a humidity of air flowing in the intake flow path 15.

The dehumidification unit 80 may regulate a humidity of the outdoor air A1 flowing in the intake flow path 15 and may additionally regulate a temperature thereof.

The dehumidification unit 80 may include the heat exchanger 81 provided to exchange heat with the outdoor air A1 flowing in the intake flow path 15, and a drain tray 82 provided to collect condensate generated from the heat exchanger 81.

The heat exchanger 81 may be provided as a pair. A pair of the heat exchangers 81 may each exchange heat with the outdoor air A1. The pair of heat exchangers 81 may be operated in a mode in which both the heat exchangers become evaporators, or may also be operated in a mode in which one of the heat exchangers becomes an evaporator and the other heat exchanger becomes a condenser.

As described above, as the heat exchanger 81 is operated in various modes, optionally, the outdoor air A1 may be dehumidified while the temperature of the outdoor air A1 is maintained, or the outdoor air A1 may be dehumidified while being cooled.

However, the heat exchanger 81 is not limited thereto and may be provided as a single heat exchanger to mainly dehumidify the outdoor air A1.

The dehumidification unit 80 may be provided on the intake flow path 15. The dehumidification unit 80 may be disposed inside the second intake chamber 17b. That is, the dehumidification unit 80 may be disposed further downstream of the intake flow path 15 than the total heat exchanger 71.

The housing 10 may include a first housing 30 and a second housing 20 provided to be coupled to the first housing 30 in an up-down direction Z.

The ventilation apparatus 1 may include covers 40 and 50 provided to cover the housing 10. The covers 40 and 50 may be provided to form an external appearance of the ventilation apparatus 1.

The covers 40 and 50 may include the first cover 50 disposed at a lower portion in the up-down direction Z, and the second cover 40 disposed above the first cover 50 in the up-down direction Z and coupled to the first cover 50.

The housing 10 may be formed of an insulation material. For example, the housing 10 may be provided as EPS insulation material such as Styrofoam. However, the housing 10 is not limited thereto and may be formed of various insulation materials provided to maintain a temperature of air flowing in the intake flow path 15 and a temperature of air flowing in the discharge flow path 16 at constant temperatures.

The covers 40 and 50 may be provided to cover the housing 10 formed of an insulation material to protect the housing 10 from the outside. The covers 40 and 50 may be formed of an injection molded material such as plastic.

According to an embodiment of the present disclosure, names of the components are referred to as the housing 10 and the covers 40 and 50, but the housing 10 may also be referred to as the insulation material 10, and the covers 40 and 50 may also be referred to as the housings 40 and 50. However, hereinafter, the housing 10 and covers 40 and 50, which are the names of the components described above, will be described.

The ventilation apparatus 1 of the ventilation system is disposed in the indoor space I to introduce the outdoor air A1 into the indoor space I and discharge the indoor air A2 to the outdoor space O, thereby ventilating the indoor space I. The ventilation apparatus 1 may also circulate the indoor air A2.

When the ventilation apparatus 1 is disposed in the indoor space I such as a multi-family house or apartment, as illustrated in FIG. 1, the indoor space I may be provided as a pair of indoor spaces I1 and I2 that are symmetrically provided.

Based on a direction in which the outdoor air A1 is exhausted to the indoor space I, the pair of indoor spaces I1 and I2 may be formed mirror symmetrically in a left-right direction Y.

Accordingly, air conditioning facilities provided in the indoor spaces I1 and I2, respectively, may also be formed to be symmetrical in the left-right direction Y.

That is, the ventilation apparatus 1 may be disposed in the indoor space I, pipes P1 and P2 formed in the indoor space I may be provided to be connected to the first discharge port 12 and the second intake port 13 of the ventilation apparatus 1, and each of the pipes P1 and P2 may extend to each of areas Ia, Ib, Ic, and Id of indoor space I to enable ventilation in each of the areas Ia, Ib, Ic, and Id.

In this case, structures of the pipes P1 and P2 disposed in the indoor spaces I1 and I2 may also be provided to be symmetrical in the left-right direction Y.

In this case, when the ventilation apparatuses 1 of the same shape is disposed in the indoor spaces I1 and I2, respectively, the first and second intake ports 11 and 13 and the first and second discharge ports 12 and 14 may be disposed oppositely in the left-right direction Y so that it is impossible for them to be installed in the indoor spaces I1 and I2.

Accordingly, in the case of a conventional ventilation apparatus, upper and lower surfaces of the housing are installed upside down in the left-right direction Y, and a ventilation apparatus is installed in each of the pair of the indoor spaces I1 and I2.

However, in the case of the ventilation apparatus 1 according to an embodiment of the present disclosure, as described above, the dehumidification unit 80 may be provided not only for simple ventilation of the indoor space I but also for dehumidification of the indoor space I.

In this case, a user needs to cyclically withdraw the drain tray 82, which collects condensate generated from the dehumidification unit 80, from the ventilation apparatus 1 and clean the drain tray 82.

In addition, the user needs to withdraw the total heat exchanger 71 and the filter 72 from the ventilation apparatus 1 to cyclically remove foreign substances collected in the total heat exchanger 71 and the filter 72.

In the ventilation apparatus 1, withdrawal holes are provided on the housing 10 and the covers 40 and 50, respectively, to allow the drain tray 82, total heat exchanger 71, and filter 72 to be withdrawn, so that the drain tray 82, total heat exchanger 71, and filter 72 may be withdrawn through the withdrawal holes, respectively.

In this case, when the upper and lower surfaces of the housing of ventilation apparatus 1 are simply installed upside down in the left-right direction Y, it may be difficult for the drain tray 82, total heat exchanger 71, and filter 72 to be withdrawn.

That is, when the ventilation apparatus 1 is upside down in the left-right direction Y, positions of the drain tray 82, total heat exchanger 71, and filter 72 are reversed in an up-down direction Z and do not correspond to positions of the withdrawal holes formed in the ventilation apparatus 1 in the up-down direction Z, so that the drain tray 82, total heat exchanger 71, and filter 72 may not be withdrawn.

In order to avoid this, the pair of ventilation apparatuses 1 need to be manufactured with types corresponding to the indoor spaces I1 and I2, respectively, or air conditioning facilities for the indoor spaces I1 and I2 need to be formed differently, but this may increase a manufacturing cost or cause the ventilation apparatus 1 to be inefficiently installed in the indoor space I.

Because the conventional ventilation apparatus does not include the dehumidification unit 80, regardless of whether the drain tray 82 is withdrawn, there is no problem even when the ventilation apparatus 1 is installed upside down in the left-right direction Y.

In addition, in the case of the conventional ventilation apparatus, the total heat exchanger 71 and the filter 72 may be provided to be withdrawn from the ventilation apparatus 1. In the case of the conventional ventilation apparatus, the total heat exchanger 71 and the filter 72 are arranged symmetrically in the left-right direction Y or a front-rear direction X with respect to on one of central axes L and S based on the long central axis L extending parallel to a long side of the housing 10 and the short central axis S extending parallel to a short side of the housing 10.

However, unlike an embodiment of the present disclosure, the housing 10 may be provided such that the short side extends in the left-right direction Y and the long side extends in the front-rear direction X, and thus directions in which the long central axis L and the short central axis S extend may be different.

In addition, withdrawal holes corresponding to upper and lower ends thereof, respectively, are formed in the housing 10 and covers 40 and 50 in the up-down direction Z so that the total heat exchanger 71 and the filter 72 may be withdrawn from the ventilation apparatus in both directions with respect to the up-down direction Z.

Accordingly, even when the ventilation apparatus 1 is installed upside down in the left-right direction Y, the total heat exchanger 71 and the filter 72 may be withdrawn from the ventilation apparatus 1 in any direction in the up-down direction Z through the withdrawal hole formed at the upper end or the withdrawal hole formed at the lower end.

However, in the case of the ventilation apparatus 1 according to an embodiment of the present disclosure, the dehumidification unit 80 is disposed inside the housing 10, so that it is difficult for the dehumidification unit 80 as well as the total heat exchanger 71 and the filter 72 to be arranged symmetrically with respect to any one of the central axes L and S.

That is, as the dehumidification unit 80, total heat exchanger 71, and filter 72 are all required to be disposed inside the housing 10, when each of the components is disposed in the left-right direction Y or front-rear direction X based on any one of the central axes L and S, it may be difficult for the ventilation apparatus 1 to be installed in the indoor space I as a size of ventilation apparatus 1 becomes too large compared to the conventional ventilation apparatus, and as the ventilation apparatus 1 becomes larger, areas of the intake flow path 15 and discharge flow path 16 formed therein increase, which may reduce efficiency.

In order to prevent or avoid the above problems in the ventilation apparatus 1 according to the present disclosure, the first housing 30 may form one surface 36 of the housing 10 and include a first hole 35 provided to be asymmetrically formed on the one surface 36 with respect to the central axis L or S of the one surface 36 extending in the long axis direction or the short axis direction of the one surface 36 and to allow the drain tray 82, the total heat exchanger 71, and the filter 72 to be withdrawn from the outside of the housing 10.

In addition, the second housing 20 may form the other surface 26 of the housing and include a second hole 25 disposed on the other surface 26 and formed in a shape corresponding to the first hole 35 in the up-down direction Z.

One of the first housing 30 and the second housing 20 may be selectively covered by the first cover 50, and the other one of the first housing 30 and the second housing 20 may be covered by the first cover 50.

That is, the first cover 50 and the second cover 40 are disposed to fixedly form lower and upper portions of the ventilation apparatus 1, respectively, one of the first housing 30 and the second housing 40 may be selectively inserted into the first cover 30 forming the lower portion of the ventilation apparatus 1, and the other one of the first housing 30 and the second housing 40 may be inserted into the second cover 40.

Accordingly, the first housing 30 may be inserted into the first cover 50 to be disposed at the lower portion of the ventilation apparatus 1, and in some cases, the second housing 20 may be inserted into the first cover 50 to be disposed at the lower portion of the ventilation apparatus 1.

When the ventilation apparatus 1 disposed on the left in the left-right direction Y based on FIG. 1 is defined as a first type ventilation apparatus 1A and the ventilation apparatus 1 disposed on the right is defined as a second type ventilation apparatus 1B, the ventilation apparatus 1 according to an embodiment of the present disclosure may be implemented as both the first type ventilation apparatus 1A and the second type ventilation apparatus 1B by changing positions of the first housing 30 and the second housing 20.

In the case of the first type ventilation apparatus 1A, the first housing 30 may be provided to form the lower portion of the housing 10 in the up-down direction Z and to be inserted into the first cover 50. Accordingly, the second housing 20 may be provided to be disposed at an upper portion of the first housing 30 in the up-down direction Z.

Internal components of the housing 10, such as the blowers 61 and 62, the dehumidification unit 80, the total heat exchanger 71, and the filter 72, may be mounted based on an internal shape of the first housing 30. As will be described later, the drain tray 82, total heat exchanger 71, and filter 72 may be disposed to correspond to the first hole 35 of the first housing 30.

In the case of the second type ventilation apparatus 1B, the second housing 20 may be provided to form the lower portion of the housing 10 in the up-down direction Z and to be inserted into the first cover 50. Accordingly, the first housing 30 may be provided to be disposed at an upper portion of the second housing 20 in the up-down direction Z.

The internal components of the housing 10, such as the blowers 61 and 62, the dehumidification unit 80, the total heat exchanger 71, and the filter 72, may be mounted based on an internal shape of the second housing 20. As will be described later, the drain tray 82, total heat exchanger 71, and filter 72 may be disposed to correspond to the second hole 25 of the second housing 20.

That is, both the first and second type ventilation apparatuses 1A and 1B may be implemented by simply changing the positions of the first and second housings 30 and 20 in the up-down direction Z. Hereinafter, an embodiment of the present disclosure will be described based on the first type ventilation apparatus 1A.

As illustrated in FIG. 4, the ventilation apparatus 1 may be configured to be arranged in the order of the second cover 40 forming the upper portion of ventilation apparatus 1, the second housing 20 provided to be inserted into the second cover 40, the first housing 30 provided to be coupled to the second housing 20 at the lower portion thereof in the up-down direction Z, and the first cover 50 forming the lower portion of the ventilation apparatus 1 to cover the first housing 30.

The internal components of the housing 10, such as the blowers 61 and 62, the dehumidification unit 80, the total heat exchanger 71, and the filter 72, may be disposed to be supported on the first housing 30 or the second housing 20. However, the drain tray 82, the total heat exchanger 71, and the filter 72 may be supported to be withdrawable downward from the ventilation apparatus 1 through the first hole 35 of the first housing 30.

As described above, while the first and second housings 30 and 20 may be assembled by changing the positions thereof in the up-down direction Z, the first and second covers 50 and 40 may be disposed at the same position regardless of which type of the ventilation apparatus 1 is implemented. The second cover 40 may always form the upper portion of the ventilation apparatus 1, and the first cover 50 may always form the lower portion of the ventilation apparatus 1.

The first cover 50 may include a body part 51 having a square frame shape, a surface part 52 provided in a plate shape to be detachably coupled to the body part 51, and a lower cover part 53 provided to cover the surface part 52 from below.

Unlike the second cover 40, the first cover 50 may be provided to communicate with the housing 10 because the drain tray 82, total heat exchanger 71, and filter 72 need to be withdrawn to the outside of the ventilation apparatus 1.

For example, the surface part 52 may include a third hole 52d provided to correspond to the first hole 35 of the first housing 30.

The surface part 52 may include a plate body 52a, a first surface 52b of the plate body 52a, and a second surface 52c disposed on the opposite side of the first surface 52b.

The third hole 52d may be formed on the plate body 52a. As described above, the third hole 52d is provided to correspond to the first hole 35, and may be provided asymmetrically on the plate body 52a with respect to one of the long and short central axes L and S of the housing 10.

In the first type ventilation apparatus 1, the surface part 52 may be coupled to the body part 51 such that the first surface 52b directs downward. The third hole 52d may be provided to correspond to the first hole 35 of the first housing 30 in the up-down direction Z when the surface part 52 is coupled to the body part 51 such that the first surface 52b directs downward.

The first hole 35 and the third hole 52d have approximately the same shape and may be arranged to overlap in the up-down direction Z.

Conversely, the surface part 52 may be coupled to the body part 51 such that the second surface 52c directs downward. In this case, because the surface part 52 is turned over, the third hole 52d may be disposed in a shape reversed when coupled to the body part 51 such that the first surface 52b directs downward. This will be described in detail later.

As illustrated in FIG. 5, the drain tray 82, total heat exchanger 71, and filter 72 may be provided to be exposed to the outside downward from the ventilation apparatus 1 when the lower cover part 53 is removed from the first cover 50.

The user may withdraw the drain tray 82, total heat exchanger 71, and filter 72 downward from the ventilation apparatus 1 as needed.

As illustrated in FIGS. 6 to 8, external structures of the first housing 30 and the second housing 20 may be provided to be the same. As described above, the first housing 30 or the second housing 20 is provided to be selectively inserted into the first cover 50, and thus external shapes of the housings 20 and 30 need to be the same so that the both may be inserted into and supported by the first cover 50.

Conversely, the first housing 30 or the second housing 20 is provided to be selectively inserted into the second cover 40, and thus the external shapes of the housings 20 and 30 need to be the same so that the both may be inserted into and supported by the second cover 40.

The first housing 30 may include a first intake port forming part 31 forming one portion of the first intake port 11, a first discharge port forming part 32 forming one portion of the first discharge port 12, a second intake port forming part 33 forming one portion of the second intake port 13, and a second discharge port forming part 34 forming one portion of the second discharge port 14.

The first discharge port forming part 32 and the second discharge port forming part 34 may be provided to be formed symmetrically with respect to the long central axis L. In addition, the first intake port forming part 31 and the second intake port forming part 33 may be provided to be formed symmetrically with respect to the long central axis L.

This is to maintain the same shape even when the first housing 30 is reversed and disposed in the left-right direction Y.

For example, the first discharge port forming part 32 may be disposed on the right side of the ventilation apparatus 1 in the left-right direction Y when the first type ventilation apparatus 1A is provided, while the first discharge port forming part 32 may be disposed on the left side of the ventilation apparatus 1 in the left-right direction Y when the second type ventilation apparatus 1B is provided.

Likewise, the second housing 20 may include a first intake port forming part 21 forming the other portion of the first intake port 11, a first discharge port forming part 22 forming the other portion of the first discharge port 12, a second intake port forming part 23 forming the other portion of the second intake port 13, and a second discharge port forming part 24 forming the other portion of the second discharge port 14.

The first discharge port forming part 22 and the second discharge port forming part 24 may be provided to be formed symmetrically with respect to the long central axis L. In addition, the first intake port forming part 21 and the second intake port forming part 23 may be provided to be formed symmetrically with respect to the long central axis L.

The first discharge port forming part 32 of the first housing 30 and the first discharge port forming part 22 of the second housing 20, the first intake port forming part 31 of the first housing 30 and the first intake port forming part 21 of the second housing 20, the second discharge port forming part 34 of the first housing 30 and the second discharge port forming part 24 of the second housing 20, and the second intake port forming part 33 of the first housing 30 and the second intake port forming part 23 of the second housing 20 may be provided to be formed correspondingly in the up-down direction Z, respectively.

This is to ensure that the first and second discharge ports 12 and 14 and the first and second intake ports 11 and 13 are provided in the same shape even when the first housing 30 and the second housing 20 are reversed and assembled in the up-down direction Z.

The first housing 30 and the second housing 20 may include partitions provided to partition the housings into the first and second intake chambers 17a and 17b and the first and second exhaust chambers 18a and 18b, respectively.

The partitions may be provided to be formed correspondingly in the up-down direction Z.

As described above, the dehumidification unit 80 may be disposed in the second intake chamber 17b. Accordingly, the second intake chamber 17b may be provided to have a larger area than areas of the first intake chamber 17a and the first and second exhaust chambers 18a and 18b.

The first and second intake chambers 17a and 17b and the first and second exhaust chambers 18a and 18b may be formed by the one surface 36 of the housing 10 formed on the first housing 30, the other surface 26 of the housing 10 formed on the second housing 20, and a space partitioned by the partition of each of the housings 20 and 30, and may be communicated by the total heat exchanger 71, respectively.

The total heat exchanger 71 may be provided in a square shape. This is to exchange heat between the outdoor air A1 and the indoor air A2, which flow inside total heat exchanger 71, in the same amount.

The first hole 35 provided to allow the total heat exchanger 71, the filter 72, and the drain tray 82 to be withdrawn may be divided into a first area 35a in which the total heat exchanger 71 and the filter 72 are withdrawn, and a second area 35b in which the drain tray 82 is withdrawn.

According to an embodiment of the present disclosure, the first area 35a and the second area 35b may be provided in shapes that are connected to each other, but the present disclosure is not limited thereto, and the first area 35a and the second area 35b may be provided to be separated from each other.

The first area 35a may be provided in a substantially rectangular shape. As described above, this is because the total heat exchanger 71 is provided to have a square cross section and the filter 72 is disposed adjacent to the intake inlet end 71a of the total heat exchanger 71.

Therefore, in order to expose both the total heat exchanger 71 and the filter 72 to the outside, the first area 35a may be provided in a rectangular shape.

The second area 35b may be provided in a shape corresponding to a cross section of the drain tray 82. A cross-sectional shape of the second region 35b is not limited to one shape and may be formed in various shapes.

When a side on which the first intake port 11 and the second discharge port 14 are disposed in the front-rear direction X is defined as one side and a side on which the second intake port 13 and the first discharge port 12 are disposed in the front-rear direction X is defined as the other side, the total heat exchanger 71 may be disposed adjacent to one side of the housing 10 around the long central axis L. For example, the total heat exchanger 71 may be disposed closest to the first intake port 11.

This is to maximize and/or increase the area of the second intake chamber 17b in a limited internal space of the housing 10 as the dehumidification unit 80 needs to be disposed adjacent to the first discharge port 12.

Accordingly, in the first housing 30, the first area 35a of the first hole 35 may be disposed closest to the first discharge port forming part 32 of the first housing 30 around the long central axis L to correspond to the total heat exchanger 71.

Accordingly, the first hole 35 may be formed asymmetrically at a center thereof with respect to the long central axis L or the short central axis S on the one surface 36 of the first housing 30.

Assuming that the one side 36 of the first housing 30 and the other side 26 of the second housing 20 are arranged parallel to the long central axis L or the short central axis S on the same surface, the first hole 35 of the first housing 30 and the second hole 25 of the second housing 20 may be provided in a mirror symmetrical shape about a center line between the first housing 30 and the second housing 20.

In addition, the partition of the first housing 30 and the partition of the second housing 20 may also be provided in a mirror symmetrical shape about the center line between the first housing 30 and the second housing 20.

Accordingly, even when the first housing 30 and the second housing 20 are reversed in the up-down direction Z to implement the ventilation apparatus 1, the first type ventilation apparatus 1A and the second type ventilation apparatus 1B may be symmetrically arranged in the left-right direction Y.

The second type ventilation apparatus 1B will be described in greater detail below.

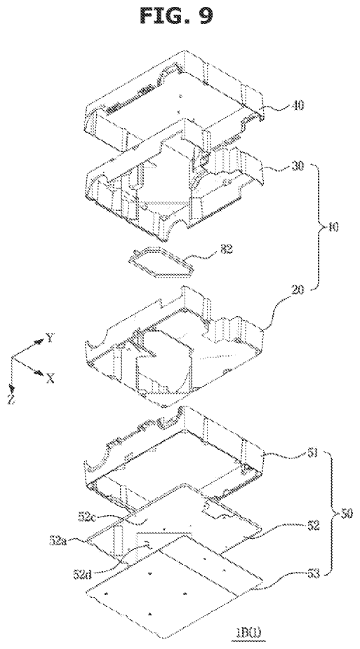

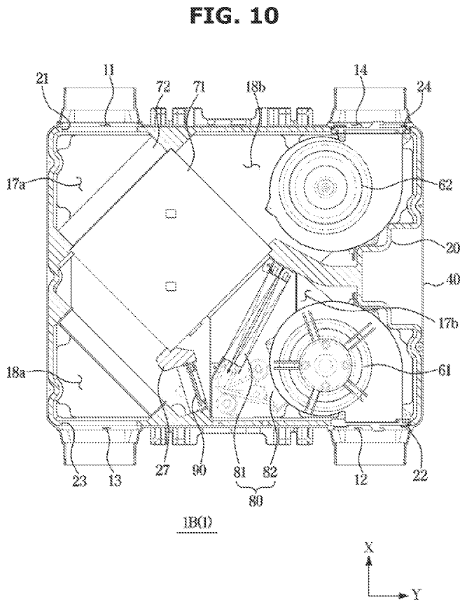

FIG. 9 is an exploded perspective view of a second type ventilation apparatus illustrated in FIG. 1 according to various embodiments, and FIG. 10 is a diagram illustrating the second type ventilation apparatus viewed from top toward bottom in a state in which a part of a configuration thereof is removed in the ventilation apparatuses illustrated in FIG. 1 according to various embodiments.

As illustrated in FIGS. 9 and 10, in the case of the second type ventilation apparatus 1B, in the up-down direction Z, the first housing 30 may be disposed on an upper side and the second housing 20 may be disposed on a lower side.

The first housing 30 may be provided to be inserted into the second cover 40, and the second housing 20 may be provided to be inserted into the first cover 50.

The dehumidification unit 80, total heat exchanger 71, and filter 72, which are the components inside the housing 10, may be disposed inside the housing 10 with the up-down direction Z reversed compared to the first type ventilation apparatus 1A.

That is, the blowers 61 and 62, total heat exchanger 71, filter 72, and dehumidification unit 80, which are accommodated inside the second type ventilation apparatus 1B based on the front-rear direction X of the first type ventilation apparatus 1A, may be mounted on the housing 10 to be reversed in the front-rear direction X.

However, as the first discharge port 12 is disposed to face forward based on the front-rear direction X of the first type ventilation apparatus 1A when the second type ventilation apparatus 1B is installed in the indoor space I2, the first and second type ventilation apparatuses 1A and 1B may be installed in the indoor space I to be symmetrical only in the left-right direction Y, respectively.

The drain tray 82, total heat exchanger 71, and filter 72 may be provided to be withdrawn to the outside of the ventilation apparatus 1 through the second hole 25 of the second housing 20.

The third hole 52d of the surface part 52 of the second cover 50 may be coupled to the body part 51 to correspond to the second hole 25.

In the second type ventilation apparatus 1B, the surface part 52 may be coupled to the body part 51 such that the second surface 52c directs downward. The third hole 52d may be provided to correspond to the second hole 25 of the second housing 20 in the up-down direction Z when the surface part 52 is coupled to the body part 51 such that the second surface 52c directs downward,

The second hole 25 and the third hole 52d may be provided to have substantially the same shape and may be arranged to overlap in the up-down direction Z.

That is, the surface part 52 may be provided to be coupled to the body part 51 with the first surface 52b and the second surface 52c reversed when the first and second housings 30 and 20 are reversed in the up-down direction Z.

Accordingly, even when the first and second housings 30 and 20 are reversed and formed as either the first or second type ventilation apparatus 1A or 1B, even in each type, the third hole 52d may be disposed on the first cover 50 at a position overlapping the first and second holes 35 and 25 in the up-down direction Z.

Hereinafter, an operation of the ventilation apparatus 1 according to an embodiment of the present disclosure will be described in greater detail below.

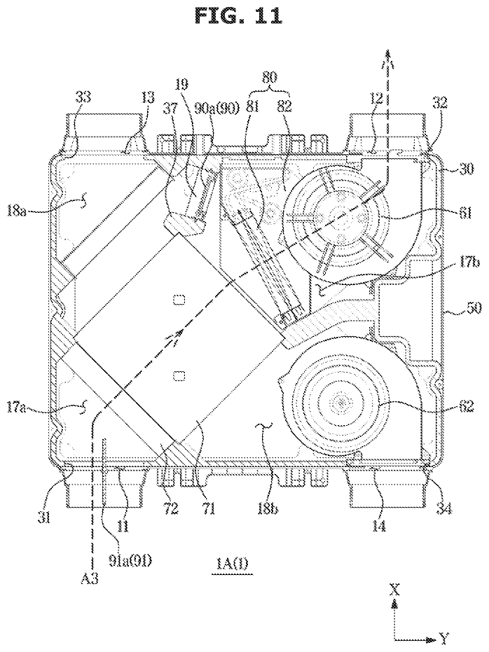

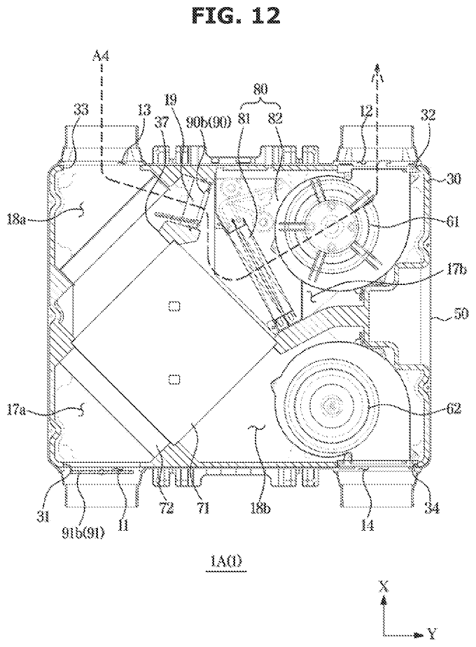

FIG. 11 is a diagram illustrating an air flow in the first type ventilation apparatus illustrated in FIG. 1 according to various embodiments, and FIG. 12 is a diagram illustrating an air flow in a mode different from a mode of the air flow shown in FIG. 11, in the first type ventilation apparatus illustrated in FIG. 1 according to various embodiments.

As illustrated in FIGS. 11 and 12, the housing 10 may include a connection flow path 19 connecting at least a portion of the intake flow path 15 and the discharge flow path 16.

For example, the connection flow path 19 may be disposed between the first exhaust chamber 18a and the second intake chamber 17b and may be disposed on a partition wall partitioning the first exhaust chamber 18a and the second intake chamber 17b (see FIG. 3).

The partition wall may be formed by a partition wall forming part 37 of the first housing 30 and a partition wall forming part 27 of the second housing 20. The connection flow path 19 may be formed by cutting at least a portion of the partition wall.

Accordingly, the first exhaust chamber 18a and the second intake chamber 17b may be provided to communicate with each other.

The ventilation apparatus 1 may include a connection flow path opening/closing unit 90 disposed on the connection flow path 19 to open and close the connection flow path 19.

The connection flow path opening/closing unit 90 may selectively open and close the connection flow path 19 to selectively communicate with the first exhaust chamber 18a and the second intake chamber 17b.

The connection flow path opening/closing unit 90 may be provided as any component capable of selectively opening and closing the connection flow path 19 by being controlled by a controller (not shown), which will be described later, such as a valve or damper.

The ventilation apparatus 1 may include a first intake port opening/closing unit 91 disposed on the first intake port 11 to selectively open and close the first intake port 11.

The ventilation apparatus 1 may include the controller (not shown) for controlling the ventilation apparatus 1 based on an indoor temperature and/or an indoor humidity and/or a discharge temperature and controlling an operation mode of the ventilation apparatus 1 depending on a selection of the user.

The controller (not shown) may be electrically connected to a temperature sensor for measuring temperatures of the indoor space I and the outdoor space O and a discharge temperature sensor (not shown) for measuring a temperature of air discharged from the ventilation apparatus 1 by wire or wirelessly, thereby receiving values measured by each of the sensors.

The ventilation apparatus 1 may be operated in outdoor dehumidification and indoor dehumidification modes. The outdoor dehumidification mode may be additionally classified into a cooling dehumidification mode and a reheating dehumidification mode. The ventilation apparatus 1 including the dehumidification unit 80 may be operated in an operation mode automatically selected by the controller (not shown) based on values measured by each of the sensors, or may be operated in an operation mode selected by the user.

A plurality of the heat exchangers 81 may be provided. The plurality of the heat exchangers 81 may all be operated as evaporators through the controller (not shown), and at least one of the plurality of heat exchangers may be operated as a condenser and the other heat exchanger may be operated as an evaporator.

In the cooling dehumidification mode, an amount of the refrigerant to be delivered to the dehumidification unit 80 is regulated or all of the plurality of heat exchangers 81 of the dehumidification unit 80 is operated as evaporators to remove moisture in air introduced from the outdoor space O and absorb heat, thereby providing cooled air to the indoor space I.

In the reheat dehumidification mode, one of the plurality of heat exchangers 81 is operated as a condenser and the other one is operated as an evaporator to remove moisture in air introduced from the outdoor space O while a temperature of air introduced into the ventilation apparatus 1 is maintained, thereby providing cooled air to the indoor space I.

In the outdoor dehumidification mode, as illustrated in FIG. 11, outdoor air A3 introduced into the ventilation apparatus 1 through the first intake port 11 may be heat-exchanged through the total heat exchanger 71, pass through the dehumidification unit 80, and be provided to the indoor space I through the first discharge port 12.

In this case, the connection flow path opening/closing unit 90 may be provided in a closed state 90a to prevent/reduce air introduced from the indoor space from mixing with the outdoor air A3.

In addition, the first intake port opening/closing unit 91 may be provided in an opened state 91a to allow the outdoor air A3 to be introduced into the ventilation apparatus 1.

In the indoor dehumidification mode, moisture in the air introduced from the indoor space I is removed while air in the indoor space I is circulated through the ventilation apparatus 1, thereby providing cooled air back to the indoor space I.

As described above, in the outdoor dehumidification mode, when outdoor air is introduced into the ventilation apparatus 1, the outdoor air may pass through the filter 72 and the total heat exchanger 71 disposed inside the ventilation apparatus 1, pass through the dehumidification unit 80, and then be exhausted to the indoor space I through the first discharge port 12.

As an amount of air introduced into the ventilation apparatus 1 increases, foreign substances collected in the filter 72 may increase and foreign substances accumulated inside total heat exchanger 71 may increase.

Accordingly, the user needs to cyclically withdraw the filter 72 and the total heat exchanger 71 from the ventilation apparatus 1 through the first hole 35 to clean the filter 72 and the total heat exchanger 71 and then to insert the cleaned filter 72 and total heat exchanger 71 back into the ventilation apparatus 1.

That is, as the amount of air passing through the filter 72 and the total heat exchanger 71 increases, the user may be required to withdraw the filter 72 and the total heat exchanger 71 from the ventilation apparatus 1 in a shorter cycle and then insert the filter 72 and the total heat exchanger 71 back into the ventilation apparatus 1. Accordingly, inconvenience may occur when the user uses the ventilation apparatus 1.

In order to address this, the ventilation apparatus 1 according to an embodiment of the present disclosure may reduce the amount of air passing through the filter 72 and the total heat exchanger 71 through the indoor dehumidification mode to increase the cycle in which the filter 72 and the total heat exchanger 71 are contaminated, thereby increasing a cleaning cycle of the filter 72 and the total heat exchanger 71.

For example, when in the indoor dehumidification mode, the ventilation apparatus 1 may restrict air, which flows in the indoor space and then is introduced into the ventilation apparatus 1 through the second intake port 13, to flow to the second discharge port 14 so that indoor air is not discharged to the outside but is circulated from the inside of the ventilation apparatus 1 back to the indoor space through the first discharge port 12.

The ventilation apparatus 1 may be disposed such that the air circulated inside the ventilation apparatus 1 passes through the dehumidification unit 80 to enable dehumidification even when indoor air is circulated.

Accordingly, in the indoor dehumidification mode, outdoor air is not introduced into the ventilation apparatus 1, so that the filter 72 and the total heat exchanger 71 may be prevented/reduced from being contaminated by foreign substances introduced from the outside, and the dehumidification may be possible when indoor air is circulated.

In addition, because indoor air passes through the filter 72 when introduced from outdoors, the indoor air is already maintained in a clean state, so that cleanliness thereof may be maintained when circulated. In the indoor dehumidification mode, as illustrated in FIG. 12, indoor air A4 introduced into the ventilation apparatus 1 through the second intake port 13 may not flow into the second discharge port 14 through the total heat exchanger 71, but may flow into the second intake chamber 17b through the connection flow path 19 to pass through the dehumidification unit 80 and be circulated to the indoor space I through the first discharge port 12.

The connection flow path opening/closing unit 90 may be provided in an opened state 90b so that the indoor air A4 introduced from the indoor space flows into the connection flow path 19.

In addition, the first intake port opening/closing unit 91 may be provided in a closed state 91b to prevent/reduce outdoor air from being introduced into the ventilation apparatus 1 and mixed with the indoor air A4.

For example, in the indoor dehumidification mode, the second blower 62 may be provided not to be operated. This is to prevent/reduce at least a part of air introduced into the second intake port 13 when the second blower 62 is operated from flowing into the second discharge port 14 through the total heat exchanger 71 without flowing into the connection flow path 19.

The controller (not shown) may include various control circuitry and control the first intake port opening/closing unit 91 to stop the operation of the second blower 62 and switch the first intake opening/closing unit 91 to the closed state 91b when the ventilation apparatus 1 is operated in the indoor dehumidification mode, and may control the connection flow path opening/closing unit 90 so that the connection flow path opening/closing unit 90 opens the connection flow path 19.

Accordingly, the ventilation apparatus 1 may be provided such that indoor air introduced into the ventilation apparatus 1 in the indoor dehumidification mode passes through the dehumidification unit 80 without passing through the filter 72 and the total heat exchanger 71, thereby preventing/reducing the filter 72 and the total heat exchanger 71 from being contaminated by outdoor air while supplying dehumidified air to the indoor space.

Based on an input of the user or values transmitted from various sensors, the controller (not shown) may control the ventilation apparatus 1 so that the ventilation apparatus 1 is operated in the outdoor dehumidification mode. In this case, the controller (not shown) may control the first blower 61 and the second blower 62, respectively, so that both the first blower 61 and the second blower 62 are operated. In addition, the controller (not shown) may control the connection flow path opening/closing unit 90 so that the connection flow path opening/closing unit 90 is maintained in the closed state 90a.

Based on an input of the user or values transmitted from various sensors, the controller (not shown) may control the ventilation apparatus 1 so that the ventilation apparatus 1 is operated in the indoor dehumidification mode. In this case, the controller (not shown) may control the first blower 61 and the second blower 62, respectively, so that the first blower 61 is operated and the second blower 62 is not operated. In addition, the controller (not shown) may control the connection flow path opening/closing unit 90 so that the connection flow path opening/closing unit 90 is in the opened state 90b. In addition, the controller may control the first intake port opening/closing unit 91 so that the first intake port opening/closing unit 91 is in the closed state 91b.

As described above, the ventilation apparatus 1 may be operated as any one of the outdoor dehumidification mode in which the outdoor air A3 is introduced into the indoor space I and the indoor dehumidification mode in which the indoor air A4 is circulated to the indoor space I is selected.

In any operating mode, the ventilation apparatus 1 may provide dehumidified air to the indoor space I.

Hereinafter, a ventilation apparatus 1′ according to another example of the present disclosure will be described in greater detail below.

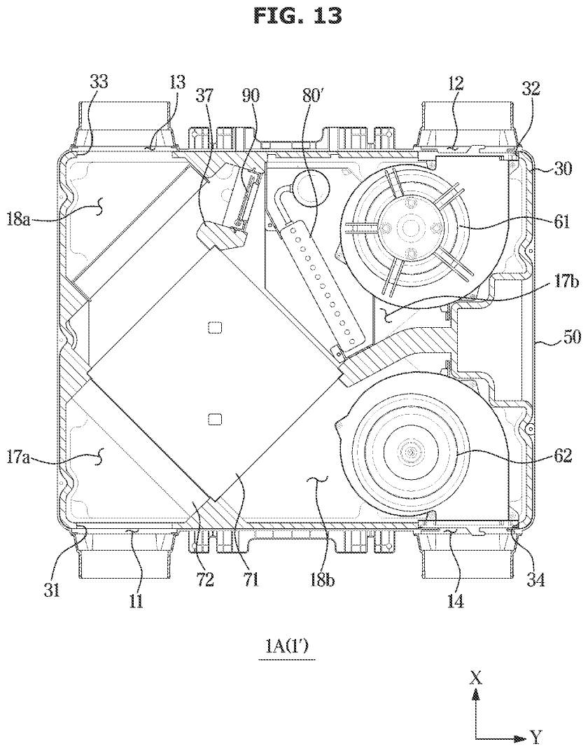

FIG. 13 is a diagram illustrating a ventilation apparatus viewed from top toward bottom in a state in which a part of the configuration of the first type ventilation apparatus is removed according to various embodiments.

The ventilation apparatus 1′ may include a humidification unit 80′ detachably disposed on the intake flow path 15 to supply moisture to air flowing in the intake flow path 15.

The humidification unit 80′ may be provided to be separable from the ventilation apparatus 1′ so as to be selectively disposed with the dehumidification unit 80 on the intake flow path 15.

The dehumidification unit 80 may be detachably provided in the ventilation apparatus 1′. Like the ventilation apparatus 1 according to an embodiment of the present disclosure, only the drain tray 82 may be provided to be withdrawn from the ventilation apparatus 1′, but the entire dehumidification unit 80, including the heat exchanger 81, may be provided to be withdrawn from the ventilation apparatus 1′.

The dehumidification unit 80 and the humidification unit 80′ may be provided to be withdrawn and inserted through the first hole 35 in the same manner based on the first type ventilation apparatus 1′.

The humidification unit 80′ may be disposed at a position where the dehumidification unit 80 is withdrawn. The humidification unit 80′ may include a plurality of nozzles provided to supply moisture into air and a storage container provided to store water.

Accordingly, as moisture is supplied to air flowing in the intake flow path 15, air containing a certain level of moisture may be discharged into the indoor space I.

That is, depending on an environment of the indoor space I, the user may selectively combine the dehumidification unit 80 or the humidification unit 80′ with the ventilation apparatus 1′ so that air appropriate for the environment of the indoor space I is supplied from the ventilation apparatus 1′.

While the disclosure has been illustrated and described with reference to various example embodiments, it will be understood by those of skilled in the art that the present disclosure is not limited to the above-described embodiments, and various changes and modifications may be made without departing from the technical idea of the present disclosure including the following claims. It will also be understood that any of the embodiment(s) described herein may be used in conjunction with any other embodiment(s) described herein.

What is claimed is:

1. A ventilation apparatus comprising:
a housing comprising an intake flow path configured to draw outdoor air into an indoor space and a discharge flow path configured to discharge indoor air to the outside;
a cover covering the housing;
a total heat exchanger configured to exchange heat between air flowing in the intake flow path and air flowing in the discharge flow path; and
a dehumidification unit comprising a heat exchanger provided on the intake flow path and configured to remove moisture in the air flowing in the intake flow path and a drain tray configured to collect condensate generated from the heat exchanger,
wherein the housing comprises:
a first housing comprising a first hole asymmetrically formed on one surface of the housing with respect to a center line of the one surface extending in a long axis direction and a short axis direction of the one surface and configured to allow the drain tray and the total heat exchanger to be withdrawn from the outside of the housing; and
a second housing coupled to the first housing in an up-down direction and comprising a second hole disposed on the other surface of the housing and having a shape corresponding to the first hole in the up-down direction,
wherein the cover comprises a first cover forming a lower portion of the cover and a second cover coupled to the first cover in the up-down direction and forming an upper portion of the cover, and
wherein one of the first housing and the second housing is covered by the first cover, and an other one of the first housing and the second housing is covered by the second cover.

2. The ventilation apparatus according to claim 1, further comprising
a filter disposed on the intake flow path and configured to remove foreign substances in air flowing to the total heat exchanger,
wherein the filter is configured to be withdrawn to the outside of the housing through the first hole.

3. The ventilation apparatus according to claim 2, wherein
the housing comprises a first intake port configured to allow air to be introduced into the intake flow path and a first discharge port configured to allow the air flowing in the intake flow path to be discharged to the outside of the housing, wherein
the filter is positioned closer to the first intake port than an intake end of the total heat exchanger disposed on the intake flow path and disposed to be parallel to and in close contact with the intake end of the total heat exchanger disposed on the intake flow path.

4. The ventilation apparatus according to claim 3, wherein
the total heat exchanger has a square cross section,
the first hole comprises a first area in which the total heat exchanger and the filter are configured to be withdrawn and a second area in which the drain tray is configured to be withdrawn, and
the first area has a rectangular shape.

5. The ventilation apparatus according to claim 1, wherein
The housing comprises a first intake port disposed on one side of the housing configured to allow air to be introduced into the intake flow path, a first discharge port disposed on an other side opposite to the one side of the housing configured to allow air flowing in the intake flow path to be discharged to the outside of the housing, a second intake port disposed on an other side of the housing configured to allow air to be introduced into the discharge flow path, and a second discharge port disposed on the one side of the housing configured to allow air flowing in the discharge flow path to be discharged to the outside of the housing, wherein
the total heat exchanger is disposed closer to the one side of the housing than an other side of the housing based on a center line extending from a center of the one side and the other side of the housing in a direction in which the one side and the other side of the housing extend.

6. The ventilation apparatus according to claim 5, wherein
the first hole comprises a first area through which the total heat exchanger is configured to be withdrawn and a second area through which the drain tray is configured to be withdrawn, wherein
the first area is disposed closer to the one side of the housing than an other side of the housing based on the center line extending from the center of the one side and the other side of the housing in the direction in which the one side and the other side of the housing extend.

7. The ventilation apparatus according to claim 5, wherein
the housing comprises a first intake chamber forming one portion of the intake flow path and formed between the first intake port and the total heat exchanger, a second intake chamber forming an other portion of the intake flow path and formed between the total heat exchanger and the first discharge port, a first exhaust chamber forming one portion of the discharge flow path and formed between the second intake port and the total heat exchanger, and a second exhaust chamber forming an other portion of the discharge flow path and formed between the total heat exchanger and the second discharge port, and
the dehumidification unit is disposed in the second intake chamber.

8. The ventilation apparatus according to claim 7, wherein
the second intake chamber has a larger internal space than the first intake chamber, the first exhaust chamber, and the second exhaust chamber.

9. The ventilation apparatus according to claim 5, wherein
the first housing comprises a first intake port forming part forming one portion of the first intake port, a first discharge port forming part forming one portion of the first discharge port, a second intake port forming part forming one portion of the second intake port, and a second discharge port forming part forming one portion of the second discharge port,
the second housing comprises a first intake port forming part forming an other portion of the first intake port, a first discharge port forming part forming an other portion of the first discharge port, a second intake port forming part forming an other portion of the second intake port, and a second discharge port forming part of an other portion of the second discharge port, and
the first discharge port forming part of the first housing and the first discharge port forming part of the second housing, the first intake port forming part of the first housing and the first intake port forming part of the second housing, the second discharge port forming part of the first housing and the second discharge port forming part of the second housing, and the second intake port forming part of the first housing and the second intake port forming part of the second housing are formed symmetrically in the up-down direction, respectively.

10. The ventilation apparatus according to claim 9, further comprising
a first blower configured to flow air in the intake flow path and a second blower configured to flow air in the discharge flow path,
wherein the first blower is configured to communicate with the first discharge port, and the second blower is configured to communicate with the second discharge port.

11. The ventilation apparatus according to claim 10, wherein
the first discharge port forming part of the first housing and the second discharge port forming part of the first housing have the same shape.

12. The ventilation apparatus according to claim 1, further comprising
a humidification unit including a humidifier detachably disposed on the intake flow path and configured to supply moisture in the air flowing in the intake flow path,
wherein the dehumidification unit is detachably disposed on the intake flow path, and
one of the humidification unit and the dehumidification unit is selectively disposed on the intake flow path.

13. The ventilation apparatus according to claim 6, wherein
the first cover comprises a body part and a surface part detachably coupled to the body part and facing an other surface of the housing, and
the surface part comprises a third hole having a shape corresponding to the first hole in the up-down direction.

14. The ventilation apparatus according to claim 13, wherein
the surface part comprises a first surface facing an other surface of the housing and a second surface disposed on an opposite side of the first surface,
the first surface is coupled to the body part to face the first housing based on the first housing being covered by the first cover, and
the second surface is coupled to the body part to face the second housing based on the second housing being covered by the first cover.

15. The ventilation apparatus according to claim 1, wherein
the housing comprises an insulation material.
